(19) United States
(12) Patent Application Publication
(10) Pub. No.: US 2026/0342093 A1
(43) Pub. Date: Oct. 29, 2026

(54) INFORMATION PROVIDING METHOD, MANAGEMENT SYSTEM, AND CHARGING AND DISCHARGING SYSTEM

(71) Applicant: GS Yuasa International Ltd., Kyoto-shi, Kyoto (JP)

(72) Inventors: Satoshi KUNITA, Kyoto-shi, Kyoto (JP); Masashi NAKAMURA

(21) Appl. No.: 19/109,071

(22) PCT Filed: Sep. 8, 2023
(86) PCT No.: PCT/JP2023/032820

§ 371 Date: Mar. 5, 2025

(30) Foreign Application Priority Data
Sep. 21, 2022 (JP) 2022-150218

(51) Int. Cl. H02J 3/32

(52) U.S. Cl. CPC H02J 3/322

(57) ABSTRACT

An information providing method includes acquiring SOC breakdown data in which an amount of charged electricity from each power source used for charging an energy storage device is recorded in association with a breakdown of a state of charge of the energy storage device, and providing, when the energy storage device is discharged, power source information indicating which power source charged the electricity being discharged, on the basis of the SOC breakdown data.

### CROSS REFERENCE TO RELATED APPLICATIONS

This application is a National Stage Application, filed under 35 U.S.C. § 371, of International Application No. PCT/JP2023/032820, filed Sep. 8, 2023, which international application claims priority to and the benefit of Japanese Application No. 2022-150218, filed Sep. 21, 2022; the contents of both of which are hereby incorporated by reference in their entirety.

### BACKGROUND

### Technical Field

The technology disclosed in the present specification relates to an information providing method, a management system for managing an energy storage device, and a charging and discharging system for the energy storage device.

### Description of Related Art

Electricity to charge an energy storage device is generated by various power sources. Japanese Unexamined Patent Application Publication No. 2016-77152 (“JP 2016-77152”) discloses an energy storage information management apparatus which stores information indicating by what power generation method the electricity charged in a storage battery has been generated.

### BRIEF SUMMARY

Recently, introduction of a Vehicle-to-Everything (V2X) system has been widely spread. The V2X system is a system for exchanging electricity between an electric vehicle and buildings or factories, and between an electric vehicle and power networks (electric power systems), or the like.

In future, it is expected that various services will be provided via the V2X system.

An object of one aspect of the present invention is to enable providing a service corresponding to information indicating which power source charged the electricity being discharged.

An information providing method includes: acquiring data in which an amount of charged electricity from each power source used for charging an energy storage device is recorded in association with a breakdown of a state of charge of the energy storage device; and providing, when the energy storage device is discharged, information indicating which power source charged the electricity being discharged, on the basis of the data.

According to the above configuration, it becomes possible to provide a service corresponding to the information indicating which power source charged the electricity being discharged.

### BRIEF DESCRIPTION OF THE FIGURES

FIG. 1 is a schematic diagram illustrating a charging and discharging system and a plurality of power sources according to Embodiment 1.

FIG. 2 is a block diagram illustrating an electrical configuration of an electric vehicle.

FIG. 3 is a block diagram illustrating an electrical configuration of the charging and discharging system.

FIG. 4 is a block diagram illustrating an electrical configuration of an energy storage apparatus.

FIG. 5 is a flowchart of SOC breakdown data update processing during a charge.

FIG. 6 is a flowchart of the SOC breakdown data update processing during a discharge.

FIG. 7 is a flowchart of service providing processing.

FIG. 8 is a flowchart of service providing processing according to Embodiment 2.

### DETAILED DESCRIPTION OF VARIOUS EMBODIMENTS

### [Outline of Embodiments]

(1) An information providing method according to an embodiment acquires data in which an amount of charged electricity from each power source used for charging an energy storage device is recorded in association with a breakdown of a state of charge (SOC) of the energy storage device, and provides, when the energy storage device is discharged, information indicating which power source charged the electricity being discharged, on the basis of the data.

The power source of electricity to charge the energy storage device includes various power sources such as a solar power generation system, a wind power generation system, and a thermal power generation system. The solar power and wind power generation systems are power sources originated from clean energy whereby the amount of carbon dioxide (CO₂) emitted during power generation is small, and the thermal power generation system or the like that uses fossil fuels is a power source originated from non-clean energy.

Recently, there is a demand for generating electrical power by using clean energy in order to realize carbon neutrality. In a case where the electricity of the energy storage device is discharged (sold or offered as power) to an electric power system by the V2X system, when the electricity is electricity that has been generated by a power source originated from clean energy, it is considered that a higher incentive is given to that electricity as compared to when electricity is generated by a power source originated from non-clean energy.

While the energy storage information management apparatus described in JP 2016-77152 stores information indicating by what power generation method the electric power charged in a storage battery has been generated, the energy storage information management apparatus does not store information on the amount of electricity that has been charged in the storage battery by using the electricity obtained by each of the power generation methods.

According to the information providing method described in (1) above, at the time when the energy storage device is discharged, information indicating which power source charged the electricity being discharged is provided. Thus, it becomes possible to give an incentive corresponding to a discharge of electricity charged from a clean-energy-originated power source. As can be seen, according to the information providing method of (1) above, it becomes possible to provide a service corresponding to the information indicating which power source charged the electricity being discharged.

In the case of measuring and recording only the amount of charged electricity from each power source by using a sensor such as a power meter without associating the amount of the charged electricity with the breakdown of the SOC of the energy storage device, there is a possibility that the energy storage device may be overcharged, and a system becomes complicated in order to prevent such an overcharge. The amount of electricity that can be held by the energy storage device (a full charge capacity of the energy storage device) decreases with the degradation of the energy storage device due to the use of the energy storage device or the passage of time. When a certain amount of electricity is charged, the proportion of the amount of the charged electricity in the SOC breakdown when the degradation of the energy storage device has progressed and a full capacity thereof is reduced is larger than that when the energy storage device is not much degraded and the full charge capacity thereof is large. The amount of electricity, which could have been charged when the energy storage device is not much degraded and the full charge capacity thereof is large, becomes unable to be charged when the degradation of the energy storage device progresses and the full capacity thereof is reduced. In the information providing method of (1) above, since the amount of the charged electricity from each power source is recorded in association with the breakdown of the SOC of the energy storage device, it is possible to prevent a system from becoming complicated in order to prevent an overcharge. As the information that has been recorded in association with the breakdown of the SOC is acquired, it is possible to provide appropriate information on the amount of the charged electricity from each power source when the energy storage device is discharged.

The above-described information providing method may be implemented by a management system such as a battery management system (BMS) or an electronic control unit (ECU) that is disposed in the vicinity of the energy storage device. The information providing method may be implemented by a charging and discharging system which charges and discharges the energy storage device, or may be implemented by a remote computer which is disposed distant from the energy storage device.

The energy storage device described above may be an energy storage cell, or may be an energy storage apparatus (an energy storage module, an energy storage pack, an energy storage system, or the like) in which a plurality of energy storage cells are combined.

The energy storage device may be mounted in a movable body such as a vehicle, or may be applied to stationary equipment.

The energy storage device mounted in the movable body may be an energy storage device (the so-called high-voltage battery) which supplies electricity to a load (for example, an electric motor) for driving the movable body, or may be an energy storage device (the so-called low-voltage battery) which supplies electricity to auxiliary devices. Preferably, the present technique should be applied to an in-vehicle high-voltage battery whose capacity is large and which can be connected to a load outside the vehicle and an electric power system in cooperation with a Vehicle to Home (V2H) system or a V2X system.

(2) In the information providing method described in (1) above, the information may be provided during a discharge of the energy storage device in a state in which the energy storage device is connected to the electric power system.

The electric power system may be an electric power system of an electric power company, or may be a microgrid in which a distributed power supply, an energy storage device, and a load are electrically connected.

A case where the energy storage device is mounted in a movable body such as a vehicle is considered. By the information providing method described above, in a state in which the energy storage device is connected to the electric power system instead of a load (a load for driving the movable body and auxiliary devices) to which the energy storage device should fundamentally supply electricity, the information indicating which power source charged the electricity being discharged is provided. By doing so, it becomes possible to give an incentive. That is, an incentive corresponding to a discharge of electricity charged from a clean-energy-originated power source can be given when the electricity is discharged from the energy storage device not for self-consumption of the electricity but for selling or offering of the electricity.

A case where the energy storage device is applied to the stationary equipment is considered. If the energy storage device records in a recording medium the amount of charged electricity from a power source originated from clean energy such as sunlight, and the amount charged electricity from a power source originated from non-clean energy in association with the breakdown of the SOC of the energy storage device, it becomes possible to give an incentive (for example, a premium price) corresponding to a discharge of the electricity charged from the clean-energy-originated power source. That is, the present technique can also be applied to the energy storage device that is always connected to the electric power system.

(3) In the information providing method described in (1) or (2) above, the breakdown of the SOC may be updated in accordance with the amount of discharge of electricity that has been charged by a power source originated from non-clean energy during a discharge of the energy storage device in a state in which the energy storage device is not connected to the electric power system.

Examples of the “power source originated from non-clean energy” include, but are not limited to, thermal power generation using fossil fuels.

When the energy storage device discharges electricity for self-consumption of the electricity, a breakdown of the SOC is updated in accordance with the amount of discharge of the electricity that has been charged by a power source originated from non-clean energy. By doing so, an appropriate incentive can be given. That is, the electricity charged with clean energy and the electricity charged with non-clean energy are managed to be virtually distinguished from each other, and the breakdown of the SOC is updated in accordance with the charge and discharge of each type of the electricity. By updating the breakdown of the SOC by assuming that a discharge in a state in which the energy storage device is not connected to the electric power system is a discharge of electricity that has been charged by a power source originated from non-clean energy, an incentive corresponding to a discharge of electricity charged by a power source originated from clean energy is maximized at the time when the energy storage device is discharged in a state in which the energy storage device is connected to the electric power system.

(4) In the information providing method described in any one of (1) to (3) above, when the energy storage device is charged, information indicating by which power source the charge is being conducted may be acquired, and the breakdown of the SOC may be updated in accordance with the amount of the charged electricity from each power source.

With the above configuration, it becomes possible to appropriately associate the amount of the charged electricity with the SOC of the energy storage device while reflecting a full charge capacity or the State of Health (SOH) of the energy storage device at the time of charge.

(5) In the information providing method described in (4) above, when the energy storage device is charged by regenerative electric power, the breakdown of the SOC may be updated by judging that the charge is being conducted by a power source originated from clean energy. According to the above configuration, by updating the SOC breakdown by assuming that a charge by the regenerative electric power, which is free of CO₂ production, is a charge conducted by a power source originated from clean energy, an incentive corresponding to a discharge of electricity charged by the power source originated from the clean energy is maximized. The regenerative electric power may be that produced in an electric motor for driving the movable body, or may be that produced in a generator mounted in the movable body such as an alternator.

(6) A management system according to an embodiment pertains to a management system for managing an energy storage device, and acquires data in which an amount of charged electricity from each power source used for charging the energy storage device is recorded in association with a breakdown of an SOC of the energy storage device, and provides, when the energy storage device is discharged, information indicating which power source charged the electricity being discharged, on the basis of the data.

The management system may be a BMS or an ECU that is disposed in the vicinity of the energy storage device, or may be a remote computer that is disposed distant from the energy storage device. The management system may be configured from a BMS and/or an ECU disposed in the vicinity of the energy storage device, and a remote computer disposed distant from the energy storage device.

According to the management system described in (6) above, it becomes possible to provide a service corresponding to the information indicating which power source charged the electricity being discharged. The BMS disposed in the vicinity of the energy storage device has a current measurement function and a voltage measurement function. In most cases, the BMS also has a temperature measurement function. The BMS can record history information (charge and discharge power information, energy storage amount information, temperature information, etc.) in a storage portion. The BMS can ascertain a self-discharge of the energy storage device, a discharge from the energy storage device to a circuit board device (a CPU or a microcomputer, etc.), and a discharge by a balancer circuit which equalizes voltage, and record those discharges or use them for the SOC update. The BMS also has a communication function. Therefore, appropriate information can be provided without using an additional sensor such as a power meter.

(7) A charging and discharging system according to an embodiment pertains to a charging and discharging system for an energy storage device, and acquires data in which an amount of charged electricity from each power source used for charging the energy storage device is recorded in association with a breakdown of an SOC of the energy storage device, and provides, when the energy storage device is discharged, information indicating which power source charged the electricity being discharged, on the basis of the data.

According to the charging and discharging system described in (7) above, it becomes possible to provide a service corresponding to the information indicating which power source charged the electricity being discharged.

### [Details of Embodiments]

Embodiments of the present disclosure will be described below. The present disclosure is not limited to these examples illustrated, but is defined by the scope of the claims and is intended to include all modifications within the meaning and scope equivalent to the scope of the claims. The embodiments of the present disclosure may be realized in various aspects, e.g., an apparatus, a method, a computer program for realizing the functions of the apparatus or the method, and a recording medium in which the computer program is recorded.

### Embodiment 1

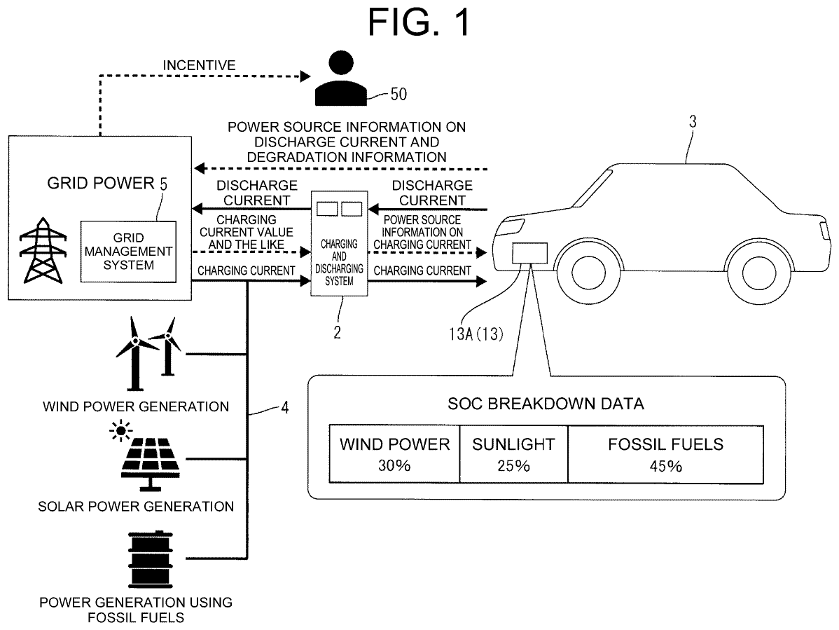

Embodiment 1 will be described with reference to FIGS. 1 to 7. In the following description, indication of reference numerals of the drawings may be omitted for the same constituent elements except for some cases.

### (1) Charging and Discharging System for Energy Storage Device

A charging and discharging system 2 according to Embodiment 1 will be described with reference to FIG. 1.

The charging and discharging system 2 (V2X system) is a system for charging and discharging an energy storage apparatus 13 mounted in an electric vehicle 3. In the following description, the energy storage apparatus 13 may be referred to as a battery.

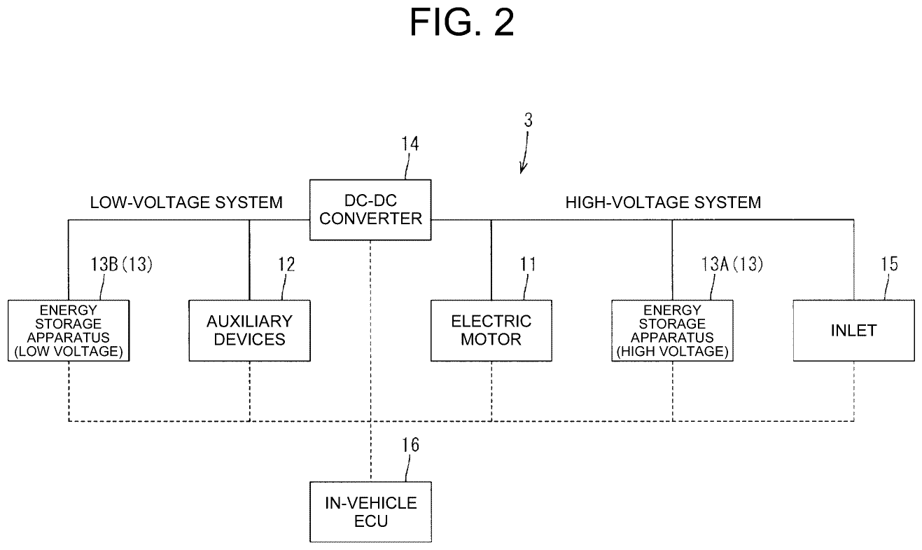

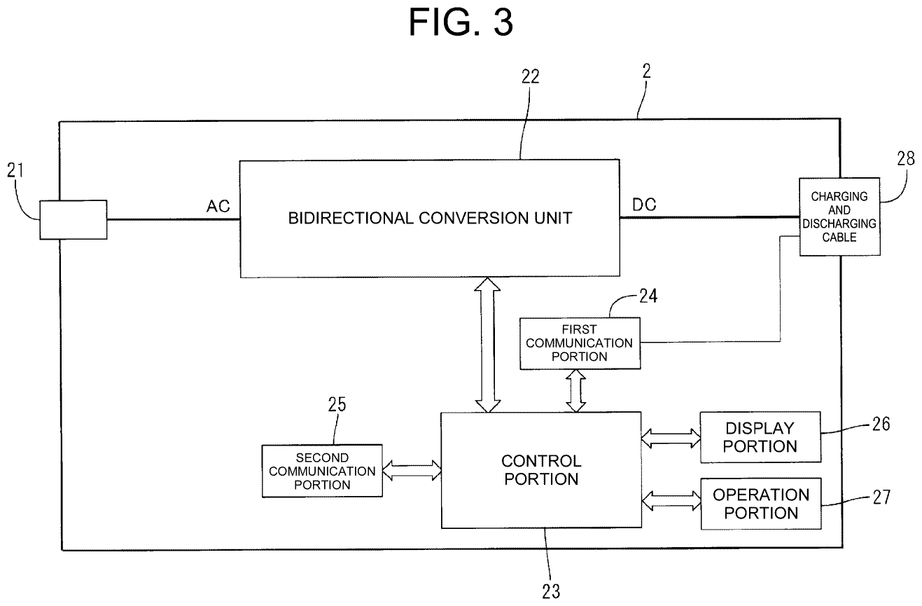

The electric vehicle 3 is a vehicle (an example of a movable body) which travels by an electric motor 11 (see FIG. 2). The electric vehicle 3 may be a battery-powered electric vehicle (BEV) or a plug-in hybrid vehicle (PHV). The electric vehicle 3 is connected to the charging and discharging system 2 via a charging and discharging cable 28 (see FIG. 3) during a charge or a discharge of the energy storage apparatus 13.

The charging and discharging system 2 is installed at, for example, a charging and discharging station or a business site. The charging and discharging system 2 may include a charger/discharger (a charging and discharging stand) and a power conditioner, and the functions of these may be packaged in a single housing. The charging and discharging system 2 is connected to a plurality of electrical power generation facilities via an electric power system 4, and is communicably connected to a grid management system 5 via a communication network (not illustrated).

The plurality of electrical power generation facilities are facilities which supply alternating-current power to the electric power system 4, and are, specifically, a wind power generation system, a solar power generation system, a power generation system using fossil fuels (for example, a thermal power generation system), and the like. The grid management system 5 manages billing of electricity charges, purchase of electricity, and the like.

Electricity stored in the energy storage apparatus 13 can be discharged (sold) to the electric power system 4 by the charging and discharging system 2.

The electric vehicle 3 is equipped with a large-capacity and high-voltage energy storage apparatus 13A, which supplies electric power to the electric motor 11, and a small-capacity and low-voltage energy storage apparatus 13B, which supplies electric power to auxiliary devices 12 (see FIG. 2). The large-capacity and high-voltage energy storage apparatus 13A records SOC breakdown data (an example of data) in which the amount of charged electricity from each power source used for charging the energy storage apparatus 13A is associated with a breakdown of an SOC of the energy storage apparatus 13A.

When the energy storage apparatus 13A is discharged (for example, when electricity is sold) in a state in which the energy storage apparatus 13A is connected to the electric power system 4, the charging and discharging system 2 transmits (provides), to the grid management system 5, information (hereinafter referred to as power source information) indicating by which power source the electricity being discharged (sold) has been charged, on the basis of the SOC breakdown data.

The grid management system 5 provides various services to a user 50 of the electric vehicle 3 on the basis of the power source information received from the charging and discharging system 2. The charging and discharging system 2 also transmits (provides), to the grid management system 5, degradation information indicating a degraded state of the energy storage apparatus 13A. The grid management system 5 also provides a service based on the degradation information of the energy storage apparatus 13A.

### (1-1) Electrical Configuration of Electric Vehicle

As illustrated in FIG. 2, the electric vehicle 3 is provided with the electric motor 11 for driving the electric vehicle 3 (i.e., a load for driving the electric vehicle 3), the auxiliary devices 12 (i.e., power steering, an electric braking system, a headlight, an air conditioner, etc.), the large-capacity and high-voltage energy storage apparatus 13A which supplies electricity to the electric motor 11, the small-capacity and low-voltage energy storage apparatus 13B which supplies electricity to the auxiliary devices 12, a DC-DC converter 14, an inlet 15 to which the charging and discharging cable 28 provided in the charging and discharging system 2 is connected, and an in-vehicle ECU 16.

The in-vehicle ECU 16 is provided with a CPU, a RAM, a storage portion, a communication portion, and the like. In the storage portion, various kinds of data and various programs to be executed by the CPU are stored. The CPU controls each part of the electric vehicle 3 by executing the program stored in the storage portion. The communication portion is a communication circuit for the CPU to communicate with the charging and discharging system 2 and each part (including the energy storage apparatus 13) of the electric vehicle 3.

Since the capacity of the energy storage apparatus 13B is small, Embodiment 1 is configured such that the electricity stored in the energy storage apparatus 13A is sold.

### (1-2) Electrical Configuration of Charging and Discharging System

As illustrated in FIG. 3, the charging and discharging system 2 is provided with an AC terminal 21, a bidirectional conversion unit 22, a control portion 23, a first communication portion 24, a second communication portion 25, a display portion 26, an operation portion 27, and the charging and discharging cable 28.

The AC terminal 21 is connected to the electric power system 4. One end of the bidirectional conversion unit 22 is connected to the AC terminal 21, and the other end thereof is connected to the charging and discharging cable 28. The bidirectional conversion unit 22 is a bidirectional conversion circuit which selectively performs forward conversion (converter function) of converting alternating-current power AC into direct-current power DC, and reverse conversion (inverter function) of converting the direct-current power DC into the alternating-current power AC.

The control portion 23 is provided with a CPU, a RAM, a storage portion, and the like. The CPU controls each part of the charging and discharging system 2 by executing a program stored in the storage portion. In the storage portion, various kinds of data and various programs to be executed by the CPU are stored.

The first communication portion 24 is a communication circuit for the CPU to communicate with the in-vehicle ECU 16. The communication may be wired communication or wireless communication. In Embodiment 1, wired communication will be described as an example.

The second communication portion 25 is a communication circuit for the CPU to communicate with an external device (such as the grid management system 5) via a communication network.

The display portion 26 is composed of a liquid crystal display, a drive circuit for driving the liquid crystal display, and the like. The operation portion 27 is composed of various operation buttons, a touch panel, and the like. As the user 50 operates the operation portion 27, he/she can perform various operations such as selecting the electrical power generation facility for charging the energy storage apparatus 13, and selling electricity being stored in the energy storage apparatus 13.

The charging and discharging cable 28 includes a power line and a signal line. When the charging and discharging cable 28 is connected to the inlet 15, the bidirectional conversion unit 22 of the charging and discharging system 2 and the energy storage apparatus 13 are electrically connected to each other via the power line. The charging and discharging system 2 charges the energy storage apparatus 13 by causing the bidirectional conversion unit 22 to perform a forward conversion operation, and discharges the energy storage apparatus 13 by causing the bidirectional conversion unit 22 to perform a reverse conversion operation.

When the charging and discharging cable 28 is connected to the inlet 15, the control portion 23 and the in-vehicle ECU 16 are communicably connected to each other via the signal line. When the control portion 23 and the in-vehicle ECU 16 are communicably connected to each other, the control portion 23 can transmit and receive information to and from the energy storage apparatus 13 via the in-vehicle ECU 16.

### (1-3) Configuration of Energy Storage Apparatus

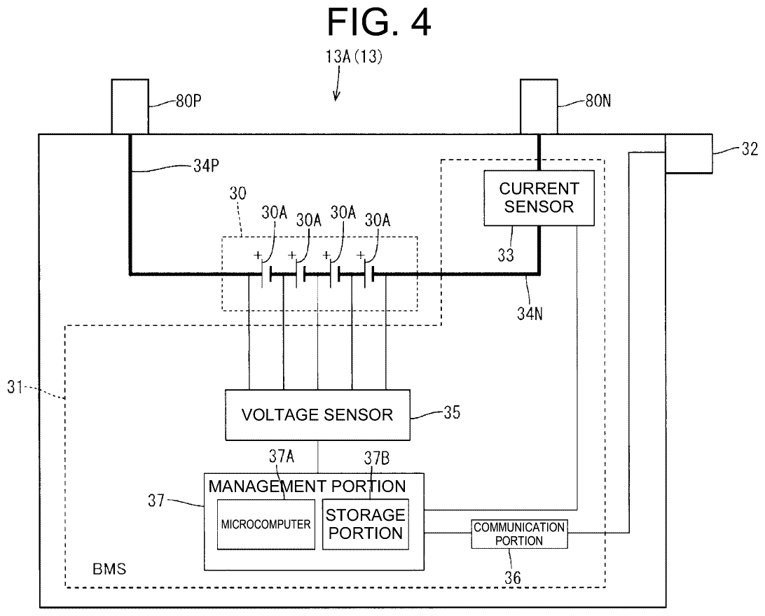

An electrical configuration of the energy storage apparatus 13A will be described with reference to FIG. 4. The energy storage apparatus 13A is provided with an assembled battery 30, a battery management system (BMS) 31, and a communication connector 32. The BMS 31 is an example of a management system. Instead of the BMS 31, a cell management unit may be used as the management system.

The assembled battery 30 is connected to a positive external terminal 80P by a power line 34P, and is connected to a negative external terminal 80N by a power line 34N. In the assembled battery 30, twelve energy storage cells 30A (an example of an energy storage device) are connected to establish a three-parallel and four-series connection. In FIG. 4, three energy storage cells 30A connected in parallel are represented by one battery symbol. The energy storage cell 30A is a repeatedly chargeable and dischargeable secondary battery, and to be more specific, is a lithium-ion secondary battery, for example.

The BMS 31 is a device which manages the energy storage apparatus 13A. The BMS 31 is provided with a current sensor 33, a voltage sensor 35, a communication portion 36, and a management portion 37. The BMS 31 is operated by electric power supplied from the assembled battery 30.

The current sensor 33 is provided at the power line 34N. The current sensor 33 measures a charge/discharge current [I] of the energy storage cell 30A and outputs the measured current to the management portion 37.

The voltage sensor 35 is connected to both ends of the respective energy storage cells 30A, measures a voltage [V] of the respective energy storage cells 30A, and outputs the measured voltage to the management portion 37.

The communication portion 36 is a circuit for the management portion 37 to communicate with the in-vehicle ECU 16.

The management portion 37 is provided with a microcomputer 37A including a CPU and a RAM, etc., as one chip, and a storage portion 37B. The management portion 37 manages each part of the energy storage apparatus 13A by executing a control program stored in the storage portion 37B. In the storage portion 37B, various kinds of data and various programs to be executed by the management portion 37 are stored. The various kinds of data include the SOC breakdown data (see FIG. 1).

The communication connector 32 is a connector to which a signal line enabling the management portion 37 to communicate with the in-vehicle ECU 16 is connected.

### (2) Power Source Information on Electricity to Charge Energy Storage Apparatus

Recently, in the field of electric power and energy, there have been attempts to apply a blockchain technology to tracking (tracing and analyzing) of electricity. The blockchain technology is a kind of a database obtained by connecting terminals on a communication network to each other, and processing and recording transaction records in a distributed manner by using an encryption technology. When a tracking system for electricity is constructed, for example, when the energy storage apparatus 13A is to be charged (more specifically, when the energy storage cells 30A are to be charged), it becomes possible to specify by which power source the energy storage apparatus 13A is being charged.

In Embodiment 1, when the user 50 of the electric vehicle 3 charges the energy storage apparatus 13A, the user 50 operates the operation portion 27 of the charging and discharging system 2 to select which type of electricity, which has been generated by the electrical power generation facility, a charge is to be conducted by, from among the electricity of the solar power generation, the wind power generation, and the power generation using fossil fuels. The charging and discharging system 2 can virtually or physically switch the electrical power generation facility, and charges the energy storage apparatus 13A with the electricity that has been produced by the selected electrical power generation facility.

As will be described in detail later, when the energy storage apparatus 13A is charged, the management portion 37 of the energy storage apparatus 13A updates the SOC breakdown data according to the power source of the charged electricity and the amount of the charged electricity. Therefore, in charging the energy storage apparatus 13A, the charging and discharging system 2 transmits, to the management portion 37 of the energy storage apparatus 13A, the information (hereinafter referred to as the power source information) indicating by which power source (sunlight, wind power, or fossil fuels) the charge is being conducted.

Specifically, the charging and discharging system 2 transmits, to the management portion 37 of the energy storage apparatus 13A, the power source information indicating the power source of the selected electrical power generation facility. Alternatively, the charging and discharging system 2 may specify the power source of the electricity supplied from grid power by a tracking system and transmit the power source information indicating the specified power source to the energy storage apparatus 13A.

The power source information may be that indicating the type of the power source (sunlight, wind power, fossil fuels), or may be that based on an ID (identification information) of the electrical power generation facility or that based on a transaction record such as a blockchain.

(3) Update of SOC Breakdown Data during Charge

The SOC breakdown data will be described with reference to FIG. 1. The SOC breakdown data is data in which the amount of charged electricity from each of the power sources used for charging the energy storage apparatus 13A is recorded in association with the breakdown of the SOC of the energy storage apparatus 13A.

The SOC breakdown data illustrated in FIG. 1 indicates that in the SOC of the energy storage apparatus 13A, 30% corresponds to the amount of electricity generated by wind power, 25% corresponds to the amount of electricity generated by sunlight, and 45% corresponds to the amount of electricity generated by fossil fuels. For example, it is assumed that the amount of electricity when the energy storage apparatus 13A is fully charged is 10000 Ah. In this case, if the current SOC is 80%, the amount of electricity being charged in the energy storage apparatus 13A is 8000 Ah (=10000×80%). Of the above, 2400 Ah (=8000×30%) is constituted by the electricity generated by wind power, 2000 Ah (=8000×25%) is constituted by the electricity generated by sunlight, and 3600 Ah (=8000×45%) is constituted by the electricity generated by fossil fuels.

As described above, the management portion 37 of the energy storage apparatus 13A receives (acquires) the power source information from the charging and discharging system 2 during a charge of the energy storage apparatus 13A. When the charge of the energy storage apparatus 13A is started, the management portion 37 measures the current value of a charging current at predetermined time intervals by the current sensor and integrates the measured current values, thereby obtaining the amount of charged electricity. Then, the management portion 37 updates the SOC breakdown data according to the power source information received from the charging and discharging system 2 and the amount of the charged electricity.

### (4) Service Provided by Grid Management System

As described above, the grid management system 5 also provides various services to the charging and discharging system 2 and the user 50 of the electric vehicle 3. In Embodiment 1, the following three services are exemplified as the services provided by the grid management system 5.
Service of deciding on a multiplying factor of an incentive for selling electricity according to a power source of the electricity to be sold and a degraded state of an energy storage apparatus
Service of notifying a charging and discharging system of an appropriate charging current value for an energy storage apparatus
Service of notifying the user of an electric vehicle that a degraded energy storage apparatus should be replaced

### (4-1) Service of Deciding on Multiplying Factor of Incentive for Selling Electricity According to Power Source of Electricity to be Sold and Degraded State of Energy Storage Apparatus

The electricity purchased by the electric power system 4 has a reference purchase price. The multiplying factor of the incentive is a value by which the reference purchase price is multiplied, and the greater the multiplying factor of the incentive is, the higher the purchase price becomes.

When the electricity of the energy storage apparatus 13A is sold (discharged) to the electric power system 4, the management portion 37 of the energy storage apparatus 13A decides which type of electricity that has been generated by the power source is to be sold on the basis of the SOC breakdown data. The decision of the power source of the electricity to be sold will be described later. The management portion 37 transmits, to the charging and discharging system 2, the power source information indicating the power source of the electricity to be sold (an example of the information indicating which power source charged the electricity being discharged), and the degradation information indicating the degraded state of the energy storage apparatus 13A.

While there are various indexes for the degraded state of the energy storage apparatus 13A, an internal resistance increase rate will be described as an example in this case. The internal resistance value of the energy storage apparatus 13A increases with degradation. The internal resistance increase rate is a value obtained by dividing the current internal resistance value of the energy storage apparatus 13A by the initial internal resistance value, and increases as the energy storage apparatus 13A is degraded.

The charging and discharging system 2 transmits the power source information and the degradation information received from the energy storage apparatus 13A to the grid management system 5. When the grid management system 5 purchases electricity from the electric vehicle 3, the grid management system 5 decides on the multiplying factor of the incentive according to the power source indicated by the received power source information and the degraded state indicated by the degradation information. An example of the multiplying factor of the incentive is indicated below.

TABLE 1

Multiplying factor of incentive

| Power source | Normal | Degraded |
|---|---|---|
| Sunlight | 1.2 times | 1.0 times |
| Wind power | 1.1 times | 0.9 times |
| Fossil fuels | 1.0 times | 0.8 times |

The fields “Normal” and “Degraded” in Table 1 indicate a degraded state of the energy storage apparatus 13A. “Normal” means that the internal resistance increase rate is less than a predetermined threshold value (that is, no degradation is caused). “Degraded” means that the internal resistance increase rate is higher than or equal to a predetermined threshold value (that is, degradation is caused). As indicated in Table 1, even with the same power source, the multiplying factor of an incentive of a “Degraded” energy storage apparatus is lower than that of a “Normal” energy storage apparatus.

The reason for the above is that because a degraded energy storage apparatus 13A should preferably be replaced early, lowering the multiplying factor of an incentive enables prompting the user 50 to replace the energy storage apparatus 13A.

As indicated in Table 1, when electricity derived from clean energy (sunlight, wind power) is sold, a multiplying factor of an incentive is higher than that when electricity derived from non-clean energy (fossil fuels) is sold. The reason for the above is that this enables prompting the user 50 to charge the energy storage apparatus 13A with electricity derived from clean energy.

### (4-2) Service of Notifying Charging and Discharging System of Appropriate Charging Current Value for Energy Storage Apparatus

When the charging and discharging system 2 charges the energy storage apparatus 13A, the energy storage apparatus 13A is charged to a predetermined SOC by a constant-voltage charge (CV charge). In the constant-voltage charge, a charging current gradually decreases with the progress of the charge. When the current value of the charging current decreases to a predetermined current value, the charging and discharging system 2 judges that the energy storage apparatus 13A has been charged to a predetermined SOC, and ends the charge.

The current value to be exhibited when the energy storage apparatus 13A is charged to a predetermined SOC varies depending on the degraded state of the energy storage apparatus 13A. For this reason, the grid management system 5 decides on a current value at which the charge is to be ended on the basis of the degraded state of the energy storage apparatus 13A, and notifies the charging and discharging system 2 of the decided current value as the above-described predetermined current value (in other words, an appropriate charging current value for the energy storage apparatus 13A). The charging and discharging system 2 ends the charge when the charging current decreases to the current value notified from the grid management system 5. Thus, the energy storage apparatus 13A is charged to the predetermined SOC irrespective of a degraded state of the energy storage apparatus 13A.

(4-3) Service of Notifying User of Electric Vehicle that Degraded Energy Storage Apparatus Should be Replaced

The grid management system 5 judges whether or not the energy storage apparatus 13A is degraded on the basis of the degradation information received from the charging and discharging system 2. When the grid management system 5 judges that the energy storage apparatus 13A is degraded, the grid management system 5 informs the user 50 that the energy storage apparatus 13A should be replaced.

As the method of informing that the energy storage apparatus 13A should be replaced, various methods can be adopted. For example, the grid management system 5 may notify the charging and discharging system 2 that the energy storage apparatus 13A should be replaced, and the charging and discharging system 2 may display a message prompting the user 50 to replace the energy storage apparatus 13A on the display portion 26. Alternatively, the grid management system 5 may transmit information prompting that the energy storage apparatus 13A should be replaced to the in-vehicle ECU 16 via the charging and discharging system 2, and the in-vehicle ECU 16 that has received the information may turn on a warning lamp prompting that the energy storage apparatus 13A should be replaced.

(5) Update of SOC Breakdown Data during Discharge

Also when the energy storage apparatus 13A is to be discharged, the management portion 37 of the energy storage apparatus 13A measures the current value of a discharge current at predetermined time intervals by the current sensor and integrates the measured current values, thereby obtaining the amount of discharged electricity. Then, the energy storage apparatus 13A updates the SOC breakdown according to a discharge destination.

The discharge destination of the energy storage apparatus 13A includes a discharge to the electric motor 11 (that is, a discharge for supplying electric power to a load for driving the electric vehicle 3), and a discharge to the electric power system 4 (that is, a discharge for selling of electricity).

When electricity is discharged (sold) to the electric power system 4, the multiplying factor of an incentive is higher if the electricity generated by clean energy is sold. Therefore, when electricity is sold to the electric power system 4, the management portion 37 presumes that the electricity charged by a power source originated from clean energy has been discharged, and transmits, to the charging and discharging system 2, information indicating sunlight or wind power as the power source information of the electricity that is sold. Further, after the electricity has been discharged to the electric power system 4, the management portion 37 reduces the ratio of electricity charged by sunlight or wind power in the SOC breakdown data in accordance with the amount of the discharged electricity.

When sunlight and wind power are compared, a multiplying factor of the incentive of the sunlight is higher. Therefore, when electricity generated by sunlight and electricity generated by wind power are stored, the management portion 37 presumes that the electricity generated by sunlight has been sold, and reduces the ratio of the electricity generated by the sunlight.

When electricity is discharged to the electric motor 11 of the electric vehicle 3, the management portion 37 presumes that the electricity generated by fossil fuels has been discharged, and reduces the ratio of the electricity generated by the fossil fuels in the SOC breakdown data in accordance with the amount of the discharged electricity. That is, the management portion 37 updates, during a discharge of the energy storage apparatus 13A in a state in which the energy storage apparatus 13A is not connected to the electric power system 4, the SOC breakdown data in accordance with the amount of discharge of the electricity that has been charged by a power source originated from non-clean energy. The reason for doing the above is that if the ratio of the amount of electricity charged from clean energy is reduced, the amount of electricity that can be sold as the electricity derived from the clean energy is reduced when the electricity is sold to the electric power system 4.

### (6) Processing Executed by Charging and Discharging System, Energy Storage Apparatus, and Grid Management System

The SOC breakdown data update processing during a charge and the SOC breakdown data update processing during a discharge that are executed by the charging and discharging system 2 and the energy storage apparatus 13A, and the service providing processing executed by the charging and discharging system 2, the energy storage apparatus 13A, and the grid management system 5 will be described.

### (6-1) SOC Breakdown Data Update Processing During Charge

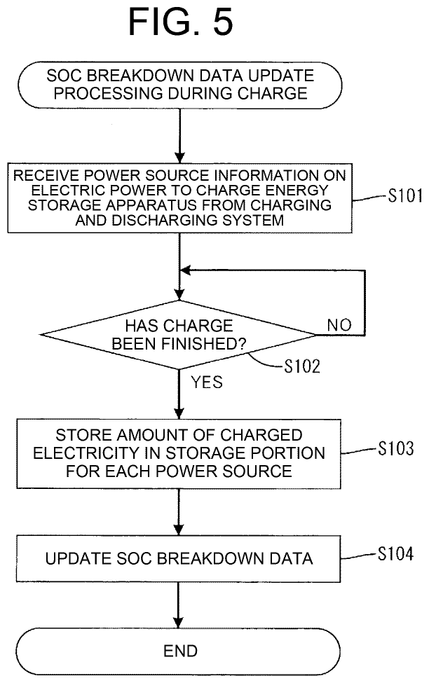

The SOC breakdown data update processing during a charge that is executed by the charging and discharging system 2 and the energy storage apparatus 13A will be described with reference to FIG. 5. The present processing is started when a charge of the energy storage apparatus 13A is started.

In S101, the management portion 37 of the energy storage apparatus 13A receives, from the charging and discharging system 2, power source information on electric power to charge the energy storage apparatus 13A.

In S102, the management portion 37 judges whether or not a charge has been finished. The management portion 37 proceeds to S103 if the charge has been finished, and repeats the processing of S102 until the charge is finished if the charge has not been finished.

In S103, the management portion 37 stores the amount of charged electricity in the storage portion 37B for each power source.

In S104, the management portion 37 updates the SOC breakdown data on the basis of the amount of charged electricity stored in S103 for each power source.

(6-2) SOC Breakdown Data Update Processing during Discharge

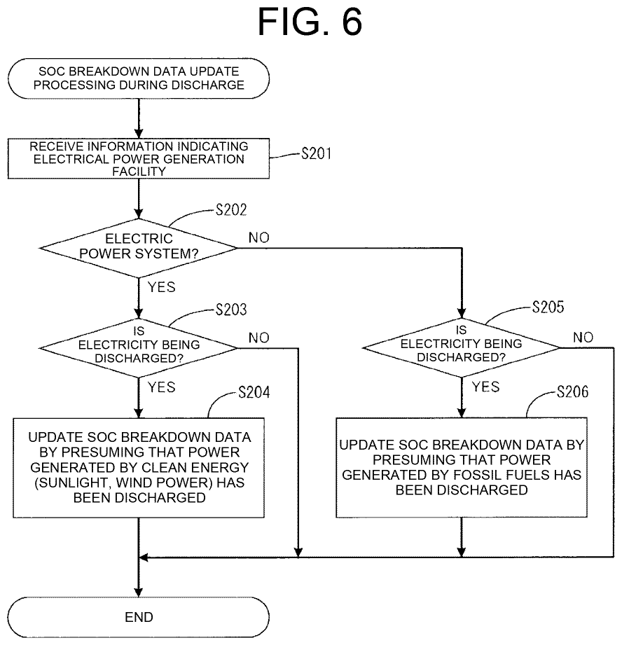

The SOC breakdown data update processing during a discharge that is executed by the energy storage apparatus 13A will be described with reference to FIG. 6. The present processing is started when the electric vehicle 3 is connected to the charging and discharging system 2.

In S201, the management portion 37 of the energy storage apparatus 13A receives, from the charging and discharging system 2, information indicating the electrical power generation facility to which the charging and discharging system 2 is connected.

In S202, the management portion 37 determines, from the received information, whether or not the energy storage apparatus 13A is connected to the electric power system 4. The management portion 37 proceeds to S203 if the energy storage apparatus 13A is connected to the electric power system 4, and proceeds to S205 if the energy storage apparatus 13A is not connected to the same.

In S203, the management portion 37 judges whether or not electricity is being discharged from the energy storage apparatus 13A to the electric power system 4. If electricity is being discharged, the management portion 37 proceeds to S204 after the discharge has been finished, and if no electricity is being discharged, the processing is ended.

In S204, the management portion 37 updates the SOC breakdown data by presuming that the electricity generated by clean energy (sunlight, wind power) has been discharged.

In S205, the management portion 37 judges whether or not the energy storage apparatus 13A is being discharged. If electricity is being discharged, the management portion 37 proceeds to S206 after the discharge has been finished, and if no electricity is being discharged, the processing is ended.

In S206, the management portion 37 updates the SOC breakdown data by presuming that the electricity generated by the fossil fuels has been discharged.

### (6-3) Service Providing Processing

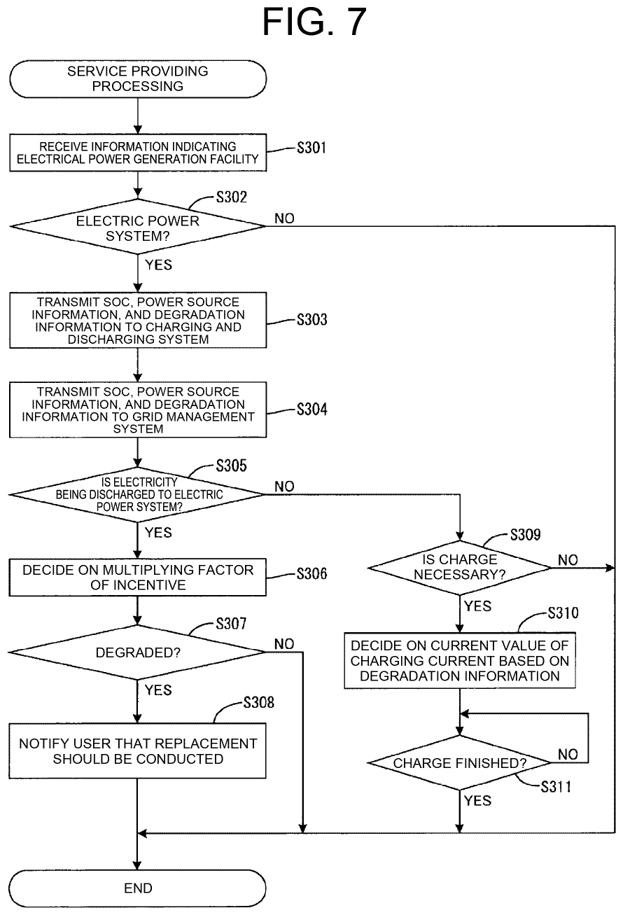

The service providing processing that is executed by the charging and discharging system 2, the energy storage apparatus 13A, and the grid management system 5 will be described with reference to FIG. 7. The present processing is started when the electric vehicle 3 is connected to the charging and discharging system 2.

In S301, the management portion 37 of the energy storage apparatus 13A receives, from the charging and discharging system 2, information indicating the electrical power generation facility to which the charging and discharging system 2 is connected.

In S302, the management portion 37 determines, from the received information, whether or not the charging and discharging system 2 is connected to the electric power system 4. The management portion 37 proceeds to S303 if connection to the electric power system 4 is established, and ends the processing if no connection to the electric power system 4 is established.

In S303, the management portion 37 reads the SOC breakdown data from the storage portion 37B, and decides which type of electricity that has been charged by the power source is presumed to be sold. Further, the management portion 37 transmits the SOC of the energy storage apparatus 13A, the power source information indicating the power source presumed to have generated the electricity to be sold, and the degradation information indicating the degraded state of the energy storage apparatus 13A to the charging and discharging system 2 via the in-vehicle ECU 16.

In S304, the control portion 23 of the charging and discharging system 2 transmits each piece of the information (the SOC, the power source information, and the degradation information) received from the management portion 37 to the grid management system 5.

In S305, the grid management system 5 determines whether or not the energy storage apparatus 13A is discharging electricity to the electric power system 4. The grid management system 5 proceeds to S306 if electricity is being discharged to the electric power system 4, and proceeds to S309 if no electricity is being discharged.

In S306, the grid management system 5 decides on a multiplying factor of the incentive according to the power source information and the degradation information.

In S307, the grid management system 5 judges whether or not the energy storage apparatus 13A is degraded on the basis of the degradation information. The grid management system 5 proceeds to S308 if the energy storage apparatus 13A is degraded, and ends the processing if the energy storage apparatus 13A is not degraded.

In S308, the grid management system 5 notifies the user 50 of the electric vehicle 3 that the energy storage apparatus 13A should be replaced.

In S309, the grid management system 5 judges whether or not a charge of the energy storage apparatus 13A by the grid power is necessary. For example, the grid management system 5 determines that a charge is necessary when the SOC is less than or equal to a predetermined threshold value. The grid management system 5 proceeds to S310 if a charge is necessary, and ends the processing if no charge is necessary.

In S310, the grid management system 5 decides on the current value of a charging current on the basis of the degradation information received from the energy storage apparatus 13A, and transmits the decided current value to the charging and discharging system 2.

In S311, the control portion 23 of the charging and discharging system 2 charges the energy storage apparatus 13A with the electricity supplied from the electric power system 4. The control portion 23 determines whether or not the charging current has decreased to the current value received from the grid management system 5, and ends the charge if the charging current has decreased to the received current value. If the charging current has not decreased to the received current value, the control portion 23 repeats the processing of S311 until the charging current is decreased.

### (7) Advantageous Effects of Embodiment

According to the information providing method of Embodiment 1, at the time of selling electricity (at the time of discharging electricity) of the energy storage cells 30A, the power source information is provided from the charging and discharging system 2 to the grid management system 5 (S304). By doing so, an incentive corresponding to a discharge of electricity charged from a clean-energy-originated power source can be given. As can be seen, according to the information providing method of Embodiment 1, it becomes possible to provide a service corresponding to the information indicating which power source charged the electricity being discharged.

According to the information providing method of Embodiment 1, in a state in which the energy storage cells 30A are connected to the electric power system 4 instead of a load (a load for driving the electric vehicle 3) to which the energy storage cells 30A should fundamentally supply electric power, the power source information is provided (S304). By doing so, it becomes possible to give an incentive. That is, an incentive corresponding to a discharge of electricity charged from a clean-energy-originated power source can be given when electricity is discharged from the energy storage cells 30A not for self-consumption of the electricity (consumption by a load for driving the electric vehicle 3) but for offering of the electricity.

According to the information providing method of Embodiment 1, when the energy storage cells 30A discharge electricity for self-consumption of the electricity, a breakdown of the SOC is updated in accordance with the amount of discharge of the electricity that has been charged by a power source originated from non-clean energy (S206). By doing so, an appropriate incentive can be given. That is, by managing the electricity charged by clean energy and the electricity charged by non-clean energy to be distinguished from each other and updating the breakdown of the SOC in accordance with the charge and discharge of each type of the electricity, an appropriate incentive, which corresponds to a discharge of the electricity that has been charged by a power source originated from clean energy, can be given at the time when the energy storage cells 30A are discharged in a state in which the energy storage cells 30A are connected to the electric power system 4.

According to the information providing method of Embodiment 1, the management portion 37 of the energy storage apparatus 13A acquires, when the energy storage cells 30A are charged, the power source information indicating by which power source the charge is being conducted, and updates the SOC breakdown data in accordance with the amount of the charged electricity from each of the power sources. Therefore, it becomes possible to appropriately associate the amount of the charged electricity with the SOC of the energy storage cells 30A while reflecting a full charge capacity or the State of Health (SOH) of the energy storage cells 30A at the time of charge.

According to the BMS 31 of Embodiment 1, it becomes possible to provide a service corresponding to the information indicating which power source charged the electricity being discharged. The BMS 31 disposed in the vicinity of the energy storage cells 30A includes the current sensor 33 (a current measurement function) and the voltage sensor 35 (a voltage measurement function). In most cases, the BMS 31 also has a temperature measurement function. The BMS 31 can record history information (charge and discharge power information, energy storage amount information, temperature information, etc.) in the storage portion 37B. The BMS 31 can ascertain a self-discharge of the energy storage cells 30A, a discharge from the energy storage cells 30A to a circuit board element (a CPU or a microcomputer, etc.), and a discharge by a balancer circuit which equalizes voltage, and record those discharges or use them for the SOC update. The BMS 31 also has a communication function. Therefore, appropriate information can be provided without using an additional sensor such as a power meter.

### Embodiment 2

A service provided by a grid management system 5 according to Embodiment 2 will be described. The grid management system 5 according to Embodiment 2 provides the service described below.
Service of deciding on a multiplying factor of an incentive according to charging efficiency of a charging and discharging system and a campaign target model

Table 2 indicated below shows an example of a multiplying factor of an incentive corresponding to the charging efficiency of a charging and discharging system 2.

TABLE 2
Multiplying factor of incentive

| | |
|---|---|
| Charging efficiency of 90% or more | 1.0 times |
| Charging efficiency of 80 to 89% | 0.9 times |
| Charging efficiency of less than 80% | 0.8 times |

In the example shown in Table 2, the lower the charging efficiency of the charging and discharging system 2 is, the lower the multiplying factor of an incentive is. The reason for the above is that if the charging efficiency of the charging and discharging system 2 is low, a loss of electricity occurs during a charge, and thus, lowering the multiplying factor of an incentive enables prompting a user 50 to conduct a charge by the charging and discharging system 2 whose charging efficiency is high.

When a charge is conducted by the charging and discharging system 2, a management portion 37 of an energy storage apparatus 13A according to Embodiment 2 receives information indicating the charging efficiency of the charging and discharging system 2 from the charging and discharging system 2 and stores the information in a storage portion 37B. When electricity is sold to an electric power system 4, the charging and discharging system 2 acquires, from the energy storage apparatus 13A, charging efficiency information indicating the charging efficiency of the charging and discharging system 2 which has charged energy storage cells 30A, and transmits the acquired charging efficiency information to the grid management system 5. The grid management system 5 decides on an incentive on the basis of the received charging efficiency information.

Table 3 indicated below shows an example of a multiplying factor of an incentive of a campaign target model and models other than the target model.

TABLE 3
Multiplying factor of incentive

| | |
|---|---|
| Campaign target model | 1.5 times |
| Other than campaign target model | 1.0 times |

A campaign is conducted, for example, for a sales promotion of a new model vehicle. In order to promote the sales of a new model vehicle, a manufacturer of an electric vehicle 3 handles that model as a campaign target model, and cooperates with an electric power company of grid power. The electric power company increases the multiplying factor of an incentive when the electric power company purchases electricity from a vehicle of the campaign target model. Since the multiplying factor of the incentive when selling the electricity of the campaign target model to the electric power system 4 is high, a desire to purchase the campaign target model is aroused.

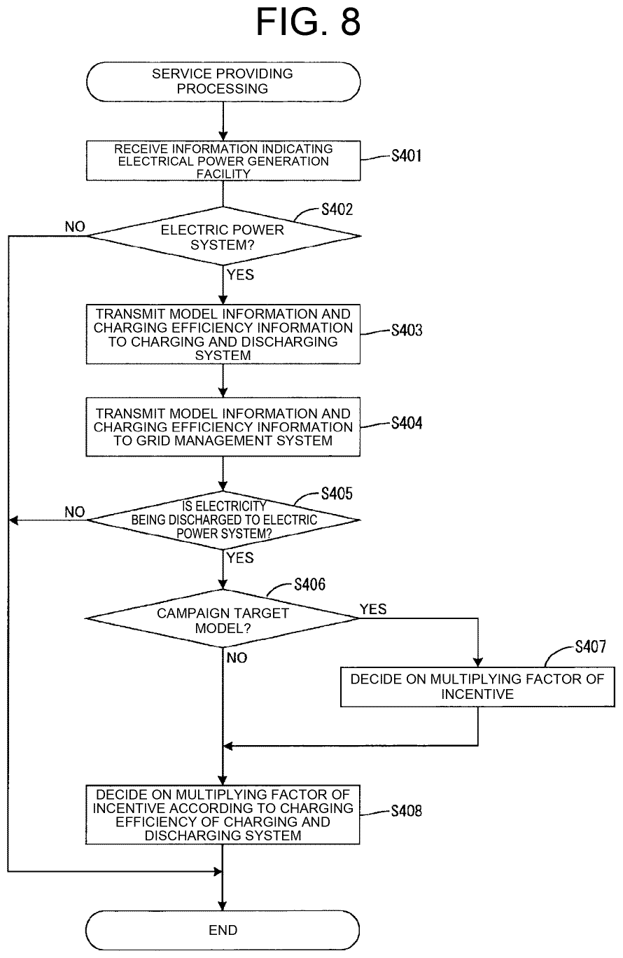

Service providing processing according to Embodiment 2 will be described with reference to FIG. 8.

In S401, the management portion 37 of the energy storage apparatus 13A receives, from the charging and discharging system 2, information indicating the electrical power generation facility to which the charging and discharging system 2 is connected.

In S402, the management portion 37 determines, from the received information, whether or not the energy storage apparatus 13A is connected to the electric power system 4. The management portion 37 proceeds to S403 if the energy storage apparatus 13A is connected to the electric power system 4, and ends the processing if the energy storage apparatus 13A is not connected to the electric power system 4.

In S403, the management portion 37 acquires model information indicating the model of the electric vehicle 3 from an in-vehicle ECU 16, and transmits, to the charging and discharging system 2, the acquired model information and the charging efficiency information indicating the charging efficiency of the charging and discharging system 2 when the energy storage apparatus 13A has been charged.

In S404, a control portion 23 of the charging and discharging system 2 transmits the received model information and charging efficiency information to the grid management system 5. Here, a case where the charging and discharging system 2 receives the model information from the management portion 37 of the energy storage apparatus 13A is exemplified. However, the charging and discharging system 2 may directly acquire the model information from the in-vehicle ECU 16.

In S405, the grid management system 5 determines whether or not the energy storage apparatus 13A is discharging (selling) electricity to the electric power system 4. The grid management system 5 proceeds to S406 if electricity is being discharged to the electric power system 4, and ends the processing if no electricity is being discharged.

In S406, the grid management system 5 determines whether or not the model in which the energy storage apparatus 13A is mounted corresponds to a campaign target model. The grid management system 5 proceeds to S407 if the model corresponds to the campaign target model, and proceeds to S408 if the model does not correspond to the campaign target model.

In S407, the grid management system 5 sets the multiplying factor of an incentive to be high.

In S408, the grid management system 5 decides on the multiplying factor of an incentive according to the charging efficiency indicated by the charging efficiency information.

According to the information providing method of Embodiment 2, an incentive corresponding to a campaign target model and the charging efficiency of the charging and discharging system 2 can be given.

### Other Embodiments

The present invention is not limited to the embodiments explained referring to the above description and the drawings, but the technical scope of the present invention also includes the following embodiments, for example.

(1) In the above-described embodiment, the energy storage cell 30A mounted in the electric vehicle 3 has been exemplified as the energy storage device. However, the energy storage device may be that applied to stationary equipment. Exemplification of the stationary equipment includes energy storage equipment for supplying electricity at the time of a power failure, and energy storage equipment used for a peak shift of the grid power.

A case where the energy storage cell 30A is applied to the stationary equipment is considered. If the energy storage cell 30A records in a recording medium the amount of electricity charged with electricity derived from clean energy such as sunlight, and the amount of electricity charged with electricity derived from non-clean energy such as fossil fuels in association with the breakdown of the SOC of the energy storage cell 30A, by use of the above-described information providing method, it becomes possible to give an incentive (for example, a premium price) corresponding to a discharge of the electricity charged from a clean-energy-originated power source. That is, the present technique can also be applied to the energy storage apparatus 13 that is always connected to the electric power system 4.

(2) In the above-described embodiment, the energy storage cell 30A has been exemplified as the energy storage device. However, the energy storage device may be an energy storage apparatus (the assembled battery 30, an energy storage module, an energy storage pack, an energy storage system, or the like) in which a plurality of energy storage cells 30A are combined.

(3) In the above-described embodiment, although the energy storage apparatus 13 (more specifically, the BMS 31) is not a constituent element of the charging and discharging system 2, the charging and discharging system 2 may include the energy storage apparatus 13 as the constituent element.

In the above-described embodiment, a case where the information providing method is implemented by the charging and discharging system 2 has been exemplified. However, the information providing method may be implemented by the BMS 31 alone. The information providing method may be implemented by a remote computer which is disposed distant from the energy storage cell 30A, or may be implemented by the in-vehicle ECU 16.

When the information providing method is implemented by an apparatus other than the BMS 31 (such as the charging and discharging system 2, a remote computer, or the in-vehicle ECU 16), these apparatuses may record the SOC breakdown data or acquire the SOC breakdown data from the BMS 31. If the information providing method is implemented by the BMS 31 alone, the BMS 31 may acquire the SOC breakdown data by reading the SOC breakdown data from the storage portion 37B.

(4) In the above-described embodiment, various services have been exemplified as the services provided by the grid management system 5. However, the services provided by the grid management system 5 may be other services as long as they correspond to the power source information.

(5) In the above-described embodiment, when the electricity stored in the energy storage cell 30A is to be sold, the electricity being stored in the small-capacity energy storage apparatus 13B is not sold. However, the electricity being stored in the energy storage apparatus 13B may be sold.

(6) In the above-described embodiment, when the energy storage cell 30A is charged, the charging and discharging system 2 acquires power source information indicating the power source which charges the energy storage cell 30A from a tracking system or the like. However, the power source information may be acquired by a power conditioner in a V2H system or a V2X system.

(7) In the above-described embodiment, the electric vehicle 3 and a plug-in hybrid vehicle have been exemplified as the movable body. However, the movable body may be an engine vehicle. Since the engine vehicle includes an engine starting device (the so-called starter motor) for starting an engine and an energy storage device for supplying electricity to auxiliary devices, the electricity being stored in that energy storage device may be sold.

(8) In the above-described embodiment, a case where an electric power company provides the grid power has been exemplified. However, the grid power may be grid power which is independent of the electric power company, or may be a power line (for example, an independent output line) for use by a power converter, such as the power conditioner, to output electricity.

(9) In the above-described embodiment, a case where the energy storage cell 30A is charged with electricity supplied from the electric power system 4 has been exemplified. However, the power source for charging the energy storage cell 30A is not limited thereto. For example, the energy storage cell 30A may be charged by regenerative electric power of the electric vehicle 3 (i.e., electricity produced by converting kinetic energy into electrical energy during deceleration of the electric vehicle 3).

In that case, the management portion 37 of the energy storage apparatus 13A may update the breakdown of the SOC by judging that the energy storage apparatus 13A is being charged by a power source originated from clean energy. By updating the SOC breakdown based on the assumption that the charge by the regenerative electric power, which is free of CO₂ production, is a charge conducted by a power source originated from clean energy, an incentive corresponding to a discharge of electricity that has been charged by the power source originated from clean energy is maximized.

The regenerative electric power may be that produced in an electric motor for driving the movable body, or may be that produced in a generator mounted in the movable body such as an alternator.

(10) In the above-described embodiment, the BMS 31 disposed in the vicinity of the energy storage cell 30A has been exemplified as the management system. However, the management system may be the in-vehicle ECU 16 or a remote computer which is disposed distant from the energy storage cell 30A. The management system may be configured from the BMS 31 and/or the in-vehicle ECU 16 disposed in the vicinity of the energy storage cell 30A, and a remote computer which is disposed distant from the energy storage cell 30A.

(11) In the above-described embodiment, a lithium-ion secondary battery has been exemplified as the energy storage cell 30A. However, the energy storage cell 30A may be a capacitor involving an electrochemical reaction.

1. An information providing method comprising:
acquiring data in which an amount of charged electricity from each power source used for charging an energy storage device is recorded in association with a breakdown of a state of charge of the energy storage device; and
providing, when the energy storage device is discharged, information indicating which power source charged the electricity being discharged, based on the data.

2. The information providing method according to claim 1, wherein the information is provided during a discharge of the energy storage device in a state in which the energy storage device is connected to an electric power system.

3. The information providing method according to claim 2, wherein the breakdown of the state of charge is updated in accordance with an amount of discharge of electricity that has been charged by a power source originated from non-clean energy during a discharge of the energy storage device in a state in which the energy storage device is not connected to the electric power system.

4. The information providing method according to claim 1, wherein
when the energy storage device is charged, information indicating which power source is conducting the charge is acquired, and the breakdown of the state of charge is updated in accordance with the amount of the charged electricity from each power source.

5. The information providing method according to claim 4, wherein when the energy storage device is charged by regenerative electric power, the breakdown of the state of charge is updated by judging that the charge is being conducted by a power source originated from clean energy.

6. A management system for managing an energy storage device, the management system implementing:
acquiring data in which an amount of charged electricity from each power source used for charging the energy storage device is recorded in association with a breakdown of a state of charge of the energy storage device; and
providing, when the energy storage device is discharged, information indicating which power source charged the electricity being discharged, based on the data.

7. A charging and discharging system for an energy storage device, the charging and discharging system implementing:
acquiring data in which an amount of charged electricity from each power source used for charging the energy storage device is recorded in association with a breakdown of a state of charge of the energy storage device; and
providing, when the energy storage device is discharged, information indicating which power source charged the electricity being discharged, based on the data.
